(19) United States
(12) Patent Application Publication
(10) Pub. No.: US 2025/0056168 A1
(43) Pub. Date: Feb. 13, 2025

(54) HEARING AID PROGRAMMING CONNECTION

(71) Applicant: Team IP Holdings, LLC, Fort Worth, TX (US)

(72) Inventor: Steve Iseberg, Schaumburg, IL (US)

(21) Appl. No.: 18/799,288

(22) Filed: Aug. 9, 2024

Related U.S. Application Data
(60) Provisional application No. 63/531,930, filed on Aug. 10, 2023.

(51) Int. Cl. H04R 25/00

(52) U.S. Cl. CPC H04R 25/556; H04R 25/505; H04R 25/602; H04R 25/604; H04R 25/609; H04R 25/652; H04R 2225/025

(57) ABSTRACT

A hearing aid system comprising a hearing aid and a programming connector. The hearing aid includes an in-ear component adapted to fit in an ear canal and a housing, which includes a microphone, memory, one or more processors, a receiver, a battery, and a programming interface. The programming interface includes a primary receiving portion including one or more conductive elements and a secondary receiving portion. The programming connector comprises a primary mating component with one or more conductive pads configured to be received by the primary receiving portion and a secondary mating component configured to be received by the secondary receiving portion. The one or more conductive elements place one or more lateral forces on the one or more conductive pads and the primary mating component and deform the one or more conductive pads and the primary mating component.

### CROSS-REFERENCE TO RELATED APPLICATIONS/INCORPORATION BY REFERENCE

The present application claims priority under 35 U.S.C. § 119(e) to provisional application Ser. No. 63/531,930 filed on Aug. 10, 2023, entitled “HEARING AID PROGRAMMING CONNECTION.” The above referenced provisional application is hereby incorporated herein by reference in its entirety.

### FIELD

The present disclosure relates to assistive hearing devices. More specifically, the present disclosure relates to improved connections for programming assistive hearing devices.

### BACKGROUND

The present disclosure pertains generally to the field of hearing aids, and more particularly to a programmable in-the-ear (ITE) or in-the-canal (ITC) hearing aid. Hearing aids have long been customizable with many different types of wired programming implemented by manufacturers. These programming connections typically have one (1) or two (2) conductors for communication along with a ground conductor and often a DC voltage. These connectors commonly require a significant force to engage and often have a mechanical detail requiring the user to orient them before engaging, making it difficult to attach when the hearing aid is located within a user's ear. Additionally, these connectors commonly use an engagement mechanism such as a door in order to retain the connector in the hearing aid.

Further limitations and disadvantages of conventional and traditional approaches will become apparent to one of skill in the art, through comparison of such systems with some aspects of the present disclosure as set forth in the remainder of the present application.

### SUMMARY

Certain embodiments of the present technology provide an improved connection between a hearing aid and a computer or other programming device while the hearing aid is active and located within a user's ear, substantially as shown in and/or described in connection with at least one of the figures.

In some embodiments, a programming interface of the hearing aid receives a programming connector that is used to provide programming instructions and/or hearing parameters to a hearing aid device while the hearing aid device is within a user's ear. Various embodiments allow a user to grip the programming connector and place the programming connector into the programming interface of the hearing aid device with a small amount of force so that a user is able to tolerate placement while the hearing aid is in a user's ear canal. Certain embodiments provide a programming interface of a hearing aid that is able to retain a programming connector within the programming interface without additional engagement mechanisms.

Various embodiments provide a programming connector that is configured and sized to easily align with the programming interface of the hearing aid in order to place the programming connector within the programming interface while the hearing aid is being worn by a user. Certain embodiments provide a programming connector with dimensions that allow for a small amount of force to accurately place the programming connector within a programming interface while aligning one or more conductive pads of the programming connector within one or more conductive elements of the programming interface.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 illustrates a block diagram of an example hearing aid system, in accordance with embodiments of the present technology.

FIG. 2A illustrates a first rear, side perspective view of an exemplary hearing aid device and a programming connector being placed in the hearing aid device, in accordance with embodiments of the present technology.

FIG. 2B illustrates a second rear, side perspective view of an exemplary hearing aid device and a programming connector being placed in the hearing aid device, in accordance with embodiments of the present technology.

FIG. 3A illustrates a rear perspective view of an exemplary hearing aid showing a programming interface connection within a programming interface of the hearing aid, in accordance with embodiments of the present technology.

FIG. 3B illustrates a detailed view of the programming interface of the hearing aid depicted in FIG. 3A, in accordance with embodiments of the present technology.

FIG. 4 illustrates a cross-sectional view of an exemplary hearing aid device showing an internal connection between a programming connector and a programming interface in the hearing aid device, in accordance with embodiments of the present technology.

FIG. 5 illustrates a side cross-sectional view of an exemplary programming interface of the hearing aid, in accordance with embodiments of the present technology.

FIG. 6 illustrates a side cross-sectional view of an exemplary programming interface of the hearing aid coupled with a programming connector, in accordance with embodiments of the present technology.

FIG. 7 illustrates a rear, side perspective view of an exemplary hearing aid device communicatively coupled to a programming connector, in accordance with embodiments of the present technology.

### DETAILED DESCRIPTION

Embodiments of the present technology provide an improved connection between a hearing aid and a computer or other programming device while the hearing aid is active and located within a user's ear.

The foregoing summary, as well as the following detailed description of certain embodiments will be better understood when read in conjunction with the appended drawings. It should be understood that the various embodiments are not limited to the arrangements and instrumentality shown in the drawings. It should also be understood that the embodiments may be combined, or that other embodiments may be utilized, and that structural, logical and electrical changes may be made without departing from the scope of the various embodiments. The following detailed description is, therefore, not to be taken in a limiting sense, and the scope of the present disclosure is defined by the appended claims and their equivalents.

As used herein, an element or step recited in the singular and preceded with the word “a” or “an” should be understood as not excluding plural of pro said elements or steps, unless such exclusion is explicitly stated. Furthermore, references to “an exemplary embodiment,” “various embodiments,” “certain embodiments,” “a representative embodiment,” and the like are not intended to be interpreted as excluding the existence of additional embodiments that also incorporate the recited features. Moreover, unless explicitly stated to the contrary, embodiments “comprising”, “including”, or “having” an element or a plurality of elements having a particular property may include additional elements not having that property.

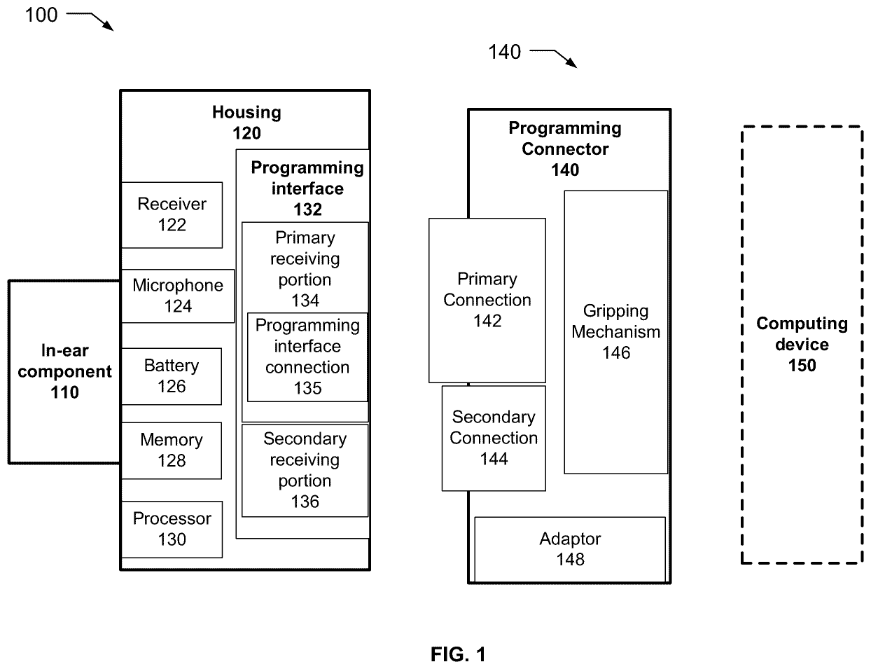

FIG. 1 illustrates a block diagram of an example hearing aid system 100, in accordance with embodiments of the present technology. The hearing aid system 100 includes an in-ear component 110, a housing 120, and a programming connector 140 or programming connector. The hearing aid system 100 includes a programming connector 140 that is used to connect the housing 120 to a computing device 150.

The housing 120 includes one or more transducers, one or more receivers 122, memory 128, one or more processors 130, a battery 126, and a programming interface 132. The one or more transducers may be microphones 124 and are configured to receive sound exterior to an ear canal. The microphones 124 convert the sound to electrical signals and provide the electrical signals to the one or more processors 130. The one or more processors 130 modify the sound level by applying programming instructions retrieved from memory 128 and/or received from the computing device 150. The programming instructions may include instructions for audio settings and/or parameters for the microphone 124 and/or receiver 122. The one or more processors 130 pass the electrical signals having the modified sound level to the receiver 122. The receiver 122 converts the electrical signals to sound, which is communicated from the receiver 122 to a user's ear canal. The programming interface 132 includes suitable logic, circuitry, interfaces, and/or code that is operable to transmit and receive information with the computing device 150 as described further below.

The programming interface 132 includes an opening or aperture. A primary receiving portion 134 and a secondary receiving portion 136 are located within the opening of the programming interface. In some examples, the primary receiving portion 134 includes a programming interface connection 135 configured to receive a primary connection 142, or primary mating component, including one or more electrical conductors from the programming connector 140. The primary receiving portion 134 may be shaped as a slot, a narrow aperture, or similar form. The programming interface connection 135 may include one or more conductive elements that provide an electrical path for electrical conductors for the connection from the programming connector 140 to the housing 120. For example, one or more electrical conductive elements may include one or more conductors for communication, a ground conductor, and/or a DC voltage.

The secondary receiving portion 136 may be an opening, such as a slot, circular opening, or other shaped opening to receive a secondary connection 144 or secondary mating component. In some examples, the primary receiving portion 134 and secondary receiving portion 136 may be electrical and/or mechanical connections. The primary receiving portion 134 and the secondary receiving portion 136 may be shaped in order to receive and retain a similarly-shaped primary connection 142 and secondary connection 144. The corresponding shaping of the primary receiving portion 134 to the primary connection 142 and the secondary receiving portion 136 to the secondary connection 144 helps in appropriately aligning the programming connector 140 to the programming interface 132 so that the programming connector 140 is properly placed and retained. Additionally, the appropriate alignment and placement of the programming connector 140 ensures that one or more electrical elements of the programming interface 132 are properly aligned and make contact with any electrically conductive elements of the programming connector 140.

The programming connector 140 may be a printed circuit board (PCB) on a substrate. The programming connector 140 includes an electrically-conductive circuit layered upon a substrate having a thin profile. The substrate may be a polyimide sheet or other similar substrate. The programming connector 140 may perform as a low-insertion-force connection. The programming connector 140 may include a primary connection 142, a secondary connection 144, and a gripping mechanism 146. In some examples, the primary connection 142 includes one or more conductive pads that may be connected to the one or more electrical conductors of the primary receiving portion 134. In some examples, the secondary connection 144 is configured to engage with the secondary receiving portion 136 of the housing. The secondary connection 144 may be a component that is shaped similarly to the secondary receiving portion 136 in order to fit within the opening of the secondary receiving portion 136.

The programming connector 140 may include a gripping mechanism 146. The gripping mechanism 146 may provide a surface to allow a user to grip the programming connector 140 in order to connect to the programming connector 140 into the housing 120. In some examples, the programming connector 140 may be placed in the housing 120 by inserting the primary connection 142 and secondary connection 144 of the programming connector 140 into the primary receiving portion 134 and the secondary receiving portion 136 of the programming interface 132 of the housing 120.

The programming connector 140 may include an adaptor 148 in order to allow a connection from the housing to a computing device. In some examples, the computing device 150 may be a tablet, PC, smartphone, etc. The computing device may store hearing aid parameters and/or configuration information in local memory or may access external database(s) containing hearing aid parameters and/or configuration information. The computing device may include wired and/or wireless interfaces. The wireless interfaces may include transceivers, such as Bluetooth, short-range, long range, Wi-Fi, cellular, personal communication system (PCS), or any suitable transceiver.

The computing device 150 may include one or more processors, one or more central processing units, microprocessors, microcontrollers, and/or the like. The one or more processors may be an integrated component, or may be distributed across various locations, for example. The one or more processors may be capable of executing a software application, receiving input information from a user input device and/or communication connection(s), and generating an output displayable by a display, among other things. The one or more processors may comprise suitable logic, circuitry, interfaces, or code configured to control software on the hearing aid device 210 and/or the computing device 150, query and update hearing aid databases, identify hearing aid fitting parameters based on measurements obtained, and upload the identified hearing aid fitting parameters to the user's hearing aid 210. In certain embodiments, the one or more processors may communicate via the programming connector 140 with the hearing aid device 210 to perform measurement control and obtain hearing measurements via the hearing aid device 210 using the programming connector 140. In various embodiments, the one or more processors may communicate with one or more local or remote hearing database to perform measurement queries and store obtained measurements. In an exemplary embodiment, the one or more processors may communicate via the programming connector 140 with the hearing aid 210 to upload the hearing aid fitting parameters. For example, the one or more processor may send hearing aid fitting parameters selected based on measurements and the hearing database queries to the hearing aid device 210.

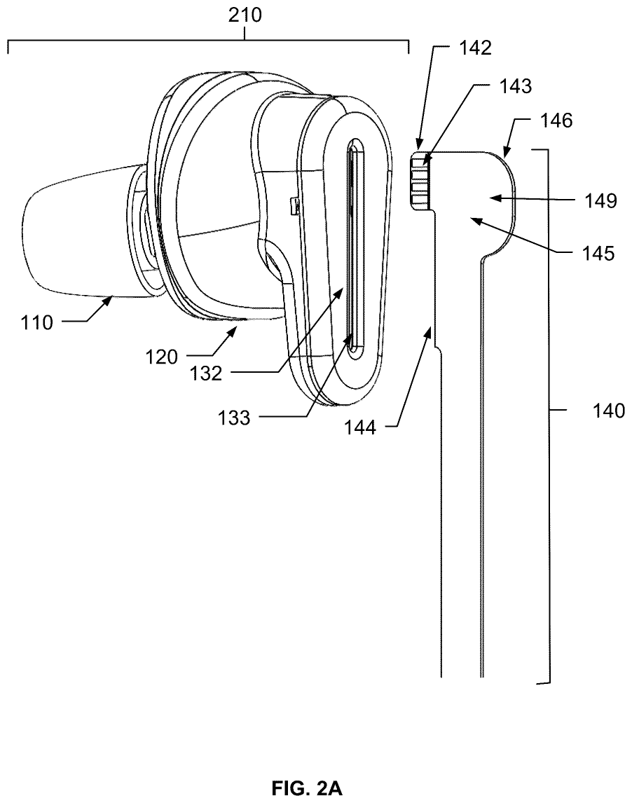

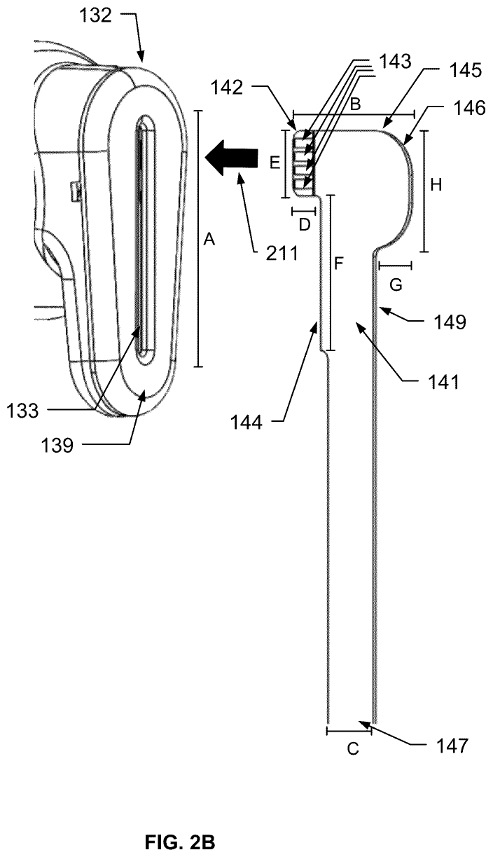

FIG. 2A illustrates a first rear, side perspective view of an exemplary hearing aid device 210 and a programming connector 140 being placed in the hearing aid device 210, in accordance with embodiments of the present technology. FIG. 2B illustrates a second rear, side perspective view of an exemplary hearing aid device 210 and a programming connector 140 being placed in the hearing aid device 210, in accordance with embodiments of the present technology.

The hearing aid device 210 includes an in-ear component 110, a housing 120, and a programming interface 132. The programming connector 140 includes a main connector portion 141, a primary connection 142, a secondary connection 144, and a gripping mechanism 146. The primary connection 142 includes one or more conductive pads 143. Although the one or more conductive pads are depicted on side 149 of the programming connector 140, the one or more conductive pads 143 may be placed on another side of the programming connector 140 or on both side of the programming connector.

The programming interface 132 includes an opening which may be circular, rectangular, elliptical, or slotted, such as programming slot 133. The programming slot 133 includes a primary receiving portion and a secondary receiving portion as described above with regards to FIG. 1, and as described further below. The programming slot 133 may be approximately 12-13 mm (see A of FIG. 2B) and configured to receive the programming connector 140. The primary receiving portion 134 and the secondary receiving portion 136 may be different depths within the programming interface 132. For example, the primary receiving portion may be a greater depth than the secondary receiving portion 136 in order to be able to accept the primary connection 142. The secondary receiving portion may be of a depth that is less than 1 mm from a front surface 139 of the programming interface 132 in order to accept the secondary connection of the programming connector 140.

The programming connector 140 includes a main connector portion 141 which includes a first end 145 and a second end 147. The primary connection 142 may be near the first end 145 of the programming connector 140. The main connector portion may include an adaptor 148 at the second end 147 to connect to a computing device 150 as described above with regards to FIG. 1. The main connector portion 141 may have a width B of approximately 8.1 mm at the first end 145 and a width C of approximately 4.1 mm at the second end 147.

The primary connection 142 of the programming connector 140 may extend approximately 1 mm (see FIG. 2B, D) from the main connector portion 141 and has a length E of approximately 3.6 mm. The secondary connection 144 may be located adjacent to the primary connection 142 and may have a length F approximately 8.4 mm long. The primary connection 142 and the secondary connection 144 may be formed so as to fit into the programming interface 132. Although the primary receiving portion 134 is depicted as being adjacent to the secondary connection 144, the primary receiving portion and the secondary receiving portion 136 may be spaced apart. Although dimensions have been provided, the dimensions provided are approximate and not intended to be limiting.

The gripping mechanism 146 may be a portion of substrate that extends outward from the main connector portion 141 of the programming connector 140. The gripping mechanism 146 may extend a distance G of approximately 3 mm from the main connector portion 141 of the programming connector 140 from a side 149 opposite the primary connection 142. The gripping mechanism 146 may have a length H of approximately 6.96 mm.

A user may grasp the main connector portion 141 and/or the gripping mechanism 146 in order to insert the programming connector 140 into the programming slot 133 while the hearing aid device 210 is within a user's ear. For example, a user may grip the programming connector 140 by the gripping mechanism 146 and/or the main connector portion 141 and push the programming connector 140 in a direction 211 towards the programming slot 133 in order to place the primary connection 142 and the secondary connection 144 into the programming slot 133. As the programming connector 140 is placed into the programming slot 133, the dimensions of the primary connection 142 and/or the secondary connection 144 allow the programming connector 140 to be seated properly within the programming interface 132 and allow the one or more conductor pads 143 to be placed in an appropriate location within the programming slot 133 relative to one or more conductive elements of the programming interface 132 so that the one or more conductive pads 143 of the programming connector 140 make electrical contact with corresponding conductive elements of the programming interface 132.

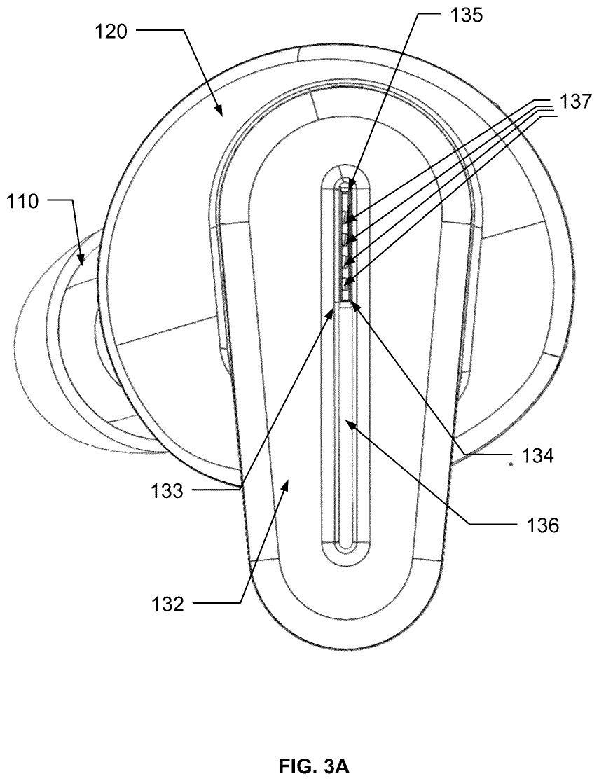

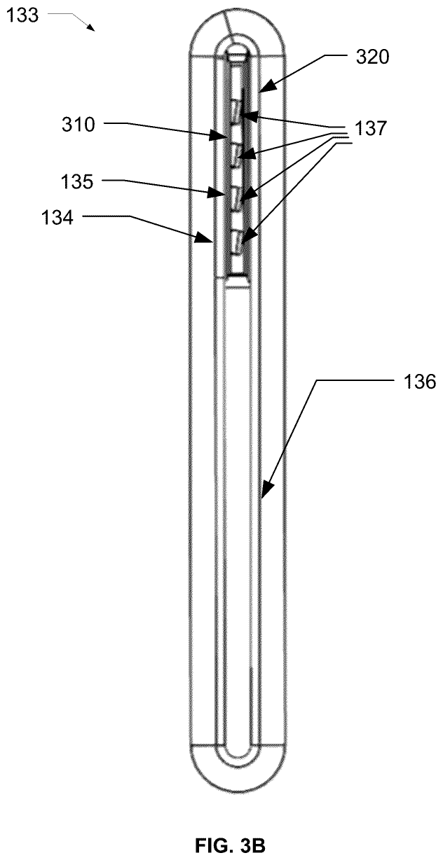

FIG. 3A illustrates a rear perspective view of an exemplary hearing aid showing a programming interface connection 135 within a programming interface 132 of the hearing aid, in accordance with embodiments of the present technology. FIG. 3B illustrates a detailed view of the programming interface 132 of the hearing aid depicted in FIG. 3A, in accordance with embodiments of the present technology. The programming slot 133 includes a primary receiving portion 134 and a secondary receiving portion 136. The primary receiving portion 134 includes a programming interface connection 135. The programming interface connection 135 includes one or more conductive elements 137. The one or more conductive elements 137 may be placed at an angle relative to the programming interface connection 135. The one or more conductive elements 137 may be placed at equidistant points relative to each other. In some examples, the one or more conductive elements 137 are placed on a first side 310 of the programming interface connection 135. In some other examples, the one or more conductive elements are placed on a second side 320 of the programming interface connection 135. If placed on the second side 320 of the programming interface connection 135, the one or more conductive elements 137 of the programming interface connection 135 should be located on a corresponding side to the programming connector 140 so that the one or more conductive pads 143 and the one or more conductive elements 137 create an electrical and/or mechanical connection.

The one or more conductive elements 137 may place lateral force(s) on the one or more conductive pads and the substrate of the programming connector 140 as the programming connector 140 is being placed into the programming interface connection 135, thereby deforming the one or more conductive pads and/or the substrate of the programming connector 140 and/or creating groove(s) and/or path(s) that may help retain the programming connector 140 within the programming slot 133. Additionally or alternatively, the internal sidewalls of the programming interface connection 135 may place additional lateral force(s) on the substrate of the programming connector 140, which may also help retain the programming connector 140 within the programming slot 133.

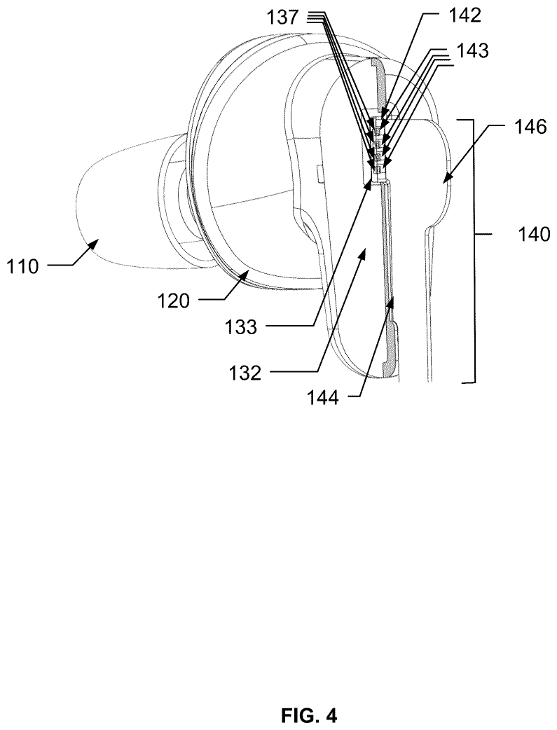

FIG. 4 illustrates a cross-sectional view of an exemplary hearing aid device 210 showing an internal connection between a programming connector 140 and a programming interface 132 in the hearing aid device 210, in accordance with embodiments of the present technology. The programming interface 132 includes an opening such as a programming slot 133. The programming slot includes a primary receiving portion 134 that includes one or more conductive elements 137. The programming connector 140 includes a gripping mechanism 146 and one or more conductive pads 143. The programming connector 140 may be placed into the programming slot 133 so the one or more conductive pads 143 of the programming connector 140 make contact with the one or more conductive elements 137 of the programming interface 132. The one or more electrical conductive elements 137 may include one or more conductors for communication, a ground conductor, and/or a DC voltage. The one or more conductive elements may create an electrical path in order for the hearing 210 to be programmed via the programming connector 140.

Because the programming connector 140 may be placed while the hearing aid device 210 is within the ear canal, the hearing aid device 210 may additionally be programmed while the hearing aid device 210 is located within the ear canal. Such programming may allow the hearing device to be programmed and tested without having to remove and reinsert the hearing aid device 210 in the user's ear.

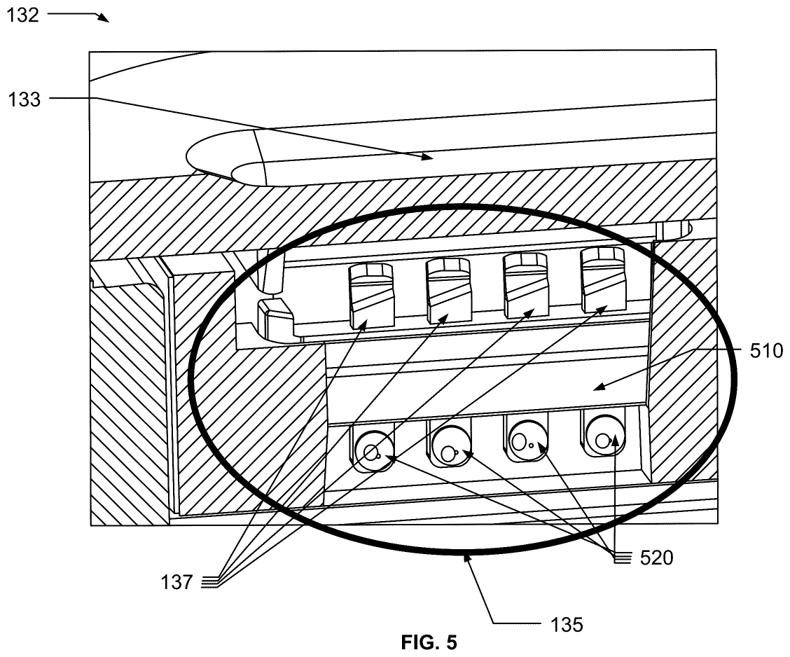

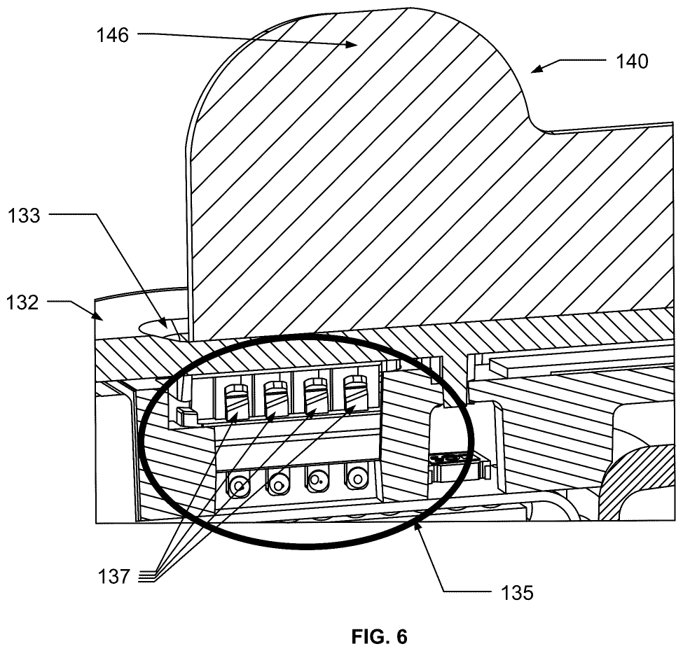

FIG. 5 illustrates a side cross-sectional view of an exemplary programming interface 132 of the hearing aid 210, in accordance with embodiments of the present technology. FIG. 6 illustrates a side cross-sectional view of an exemplary programming interface 132 of the hearing aid 210 coupled with an exemplary programming connector, in accordance with embodiments of the present technology. The programming interface 132 includes a programming slot 133 to receive the programming connector 140. The programming interface includes a programming interface connection 135. The programming interface connection 135 includes a grasping element 510 and one or more conductive elements 137. The grasping element 510 is configured to attach the one or more conductive elements 137 to the programming interface 132 at a certain location or position within the programming interface 132 to receive the one or more conductive pads 143 of the programming connector 140. The grasping element 510 may attach the one or more conductive elements 137 to the programming to the programming interface 132 using one or more fasteners 520, such as rivets, screws, etc.

The programming connector 140 includes a gripping mechanism 146 to insert the programming connector 140 into the programming slot 133. When the programming connector 140 is inserted into the programming slot 133, the one or more conductive pads 143 of the programming connector 140 make electrical contact with the one or more conductive elements 137 of the programming interface connection 135. The one or more conductive elements 137 and/or the internal portions of the programming interface connection 135, such as the grasping element place one or more lateral forces on the programming connector 140, and specifically, the substrate and/or the one or more conductive pads 143 of the programming connector 140. The one or more lateral forces deform the substrate and/or the one or more conductive pads 143 and create deformations which help retain the programming connector within the programming slot 133.

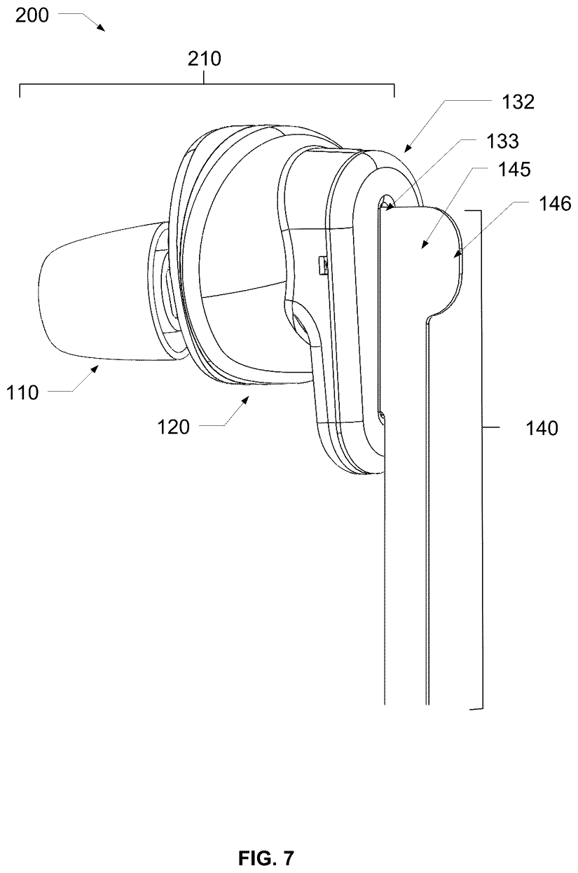

FIG. 7 illustrates a rear, side perspective view of an exemplary hearing aid device 210 communicatively coupled to a programming connector 140, in accordance with embodiments of the present technology. The programming connector 140 may be placed in the hearing aid device 210 while the hearing aid device 210 is located within a user's ear in order to provide programming instructions to the hearing aid device 210. The programming connector 140 provides an electrical connection for allowing a computing device 150 to communicate with the hearing aid device 210. This connection can be made with the hearing aid device 210 already located within the user's ear, without requiring excessive force against the ear, and without complicated alignment to engage. In some examples, the computing device 150 may communicate with the hearing aid device 210 in order to provide programming instructions and/or hearing aid parameters to the hearing aid device 210, as descried above with regards to FIG. 1.

Aspects of the present disclosure provide a system 100 including a hearing aid device including an in-ear component adapted for placement in an ear canal, a microphone configured to capture and convert audio, memory configured to store one or more programming instructions, one or more processors configured to modify the audio based on the one or more programming instructions, a receiver configured to provide the audio to the ear canal, a battery configured to provide power to the microphone, a housing configured to house the microphone, the memory, the one or more processors, the receiver, and the battery, and including a programming interface. The programming interface comprises a primary receiving portion including one or more conductive elements and configured to receive a primary mating component of a programming connector. The primary mating component includes one or more conductive pads and a secondary receiving portion configured to receive a secondary mating component of the programming connector. The primary receiving portion places one or more lateral forces on one or more conductive pads and the primary mating component and deforms the one or more conductive pads and the primary mating component using the one or more lateral forces. The primary receiving portion and the secondary receiving portion retain the programming connector within the programming interface, and the one or more programming instructions are provided using the one or more conductive elements of the primary receiving portion and the one or more conductive pads of the primary mating component.

In an exemplary embodiment, the hearing aid device is programmed while the in-ear component is located within the ear canal. In certain embodiments, the programming connector is placed while the in-ear component is within the ear canal. In representative embodiments, the programming interface is a slot interface. In some embodiments, the primary receiving portion is located at an upper portion of the programming interface.

Various embodiments provide a hearing aid device programming connector comprising an electrically-conductive circuit layered upon a substrate and a mating connection configured to be received by a programming interface of a hearing aid device. The mating connection includes one or more conductive pads configured to provide an electrical connection between the electrically-conductive circuit and the programming interface, a primary mating component configured to be received by a primary receiving portion of the programming interface, and a secondary mating component configured to be received by a secondary receiving portion of the programming interface. The one or more conductive pads and the primary mating component are adapted to be deformed by a conductive portion of the primary receiving portion of the programming interface in order to retain the mating connection, and wherein the mating connection provides a communications interface for programming the hearing aid device via the programming interface. In certain embodiments, the mating connection is located on a first end of the hearing aid device programming connector, and an adapter for connecting to a computing device is located on a second end of the hearing aid device programming connector.

Various embodiments provide a hearing aid system comprising a hearing aid and a programming connector. The hearing aid includes an in-ear component adapted to fit in an ear canal and a housing. The housing includes a microphone configured to capture and convert audio, memory configured to store one or more programming instructions, one or more processors configured to modify the audio based on the one or more programming instructions, a receiver configured to provide the audio to the ear canal, a battery configured to provide power to the microphone, and a programming interface.

The programming interface includes a primary receiving portion including one or more conductive elements and a secondary receiving portion. The programming connector comprises a primary mating component with one or more conductive pads configured to be received by the primary receiving portion and a secondary mating component configured to be received by the secondary receiving portion. The one or more conductive elements place one or more lateral forces on the one or more conductive pads and the primary mating component, deform the one or more conductive pads and the primary mating component. The primary receiving portion and the secondary receiving portion retain the programming connector within the programming interface. The one or more programming instructions are provided via the one or more conductive elements of the primary receiving portion and the one or more conductive pads of the primary mating component.

In certain embodiments, the programming connector is an electrically-conductive circuit layered upon a substrate. In exemplary embodiments, the substrate is a polyimide substrate. In some embodiments, the one or more conductive pads comprise one or more communications conductors, a ground conductor, and a DC voltage conductor. In a representative embodiment, the programming connector further comprises a gripping mechanism configured to provide an insertion force towards the primary receiving portion to insert the primary mating component into the primary receiving portion and the secondary mating component into the secondary receiving portion. In certain embodiments, the gripping mechanism includes a curvilinear edge. In some embodiments, the curvilinear edge of the primary mating component protrudes approximately 3 mm from the primary mating component.

In exemplary embodiments, an edge of the primary mating component which is inserted into the primary receiving portion is approximately 3.6 mm long. In certain embodiments, 1 mm of the edge of the primary mating component is inserted into the primary receiving portion. In some embodiments, an edge of the secondary mating component that is received by the secondary receiving portion is 8.4 mm. In certain embodiments, the hearing aid is programmed while the in-ear component is located within the ear canal. In some embodiments, the programming interface is a slot interface. In certain embodiments, the primary receiving portion is located at an upper portion of the programming interface.

As utilized herein the term “circuitry” refers to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” and/or “configured” to perform a function whenever the circuitry comprises the necessary hardware and code (if any is necessary) to perform the function, regardless of whether performance of the function is disabled, or not enabled, by some user-configurable setting.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A hearing aid device comprising:
an in-ear component adapted for placement in an ear canal;
a microphone configured to capture and convert audio;
memory configured to store one or more programming instructions;
one or more processors configured to modify the audio based on the one or more programming instructions;
a receiver configured to provide the audio to the ear canal;
a battery configured to provide power to the microphone;
a housing configured to house the microphone, the memory, the one or more processors, the receiver, and the battery, and including a programming interface, the programming interface comprising:
a primary receiving portion including one or more conductive elements and configured to receive a primary mating component of a programming connector, the primary mating component including one or more conductive pads; and
a secondary receiving portion configured to receive a secondary mating component of the programming connector,
wherein the primary receiving portion places one or more lateral forces on one or more conductive pads and the primary mating component and deforms the one or more conductive pads and the primary mating component using the one or more lateral forces, and
wherein the primary receiving portion and the secondary receiving portion retain the programming connector within the programming interface, and wherein the one or more programming instructions are provided using the one or more conductive elements of the primary receiving portion and the one or more conductive pads of the primary mating component.

2. The hearing aid device of claim 1, wherein the hearing aid device is programmed while the in-ear component is located within the ear canal.

3. The hearing aid device of claim 1, wherein the programming connector is placed while the in-ear component is within the ear canal.

4. The hearing aid device of claim 1, wherein the programming interface is a slot interface.

5. The hearing aid device of claim 1, wherein the primary receiving portion is located at an upper portion of the programming interface.

6. A hearing aid device programming connector comprising:
an electrically-conductive circuit layered upon a substrate; and
a mating connection configured to be received by a programming interface of a hearing aid device and comprising:
one or more conductive pads configured to provide an electrical connection between the electrically-conductive circuit and the programming interface;
a primary mating component configured to be received by a primary receiving portion of the programming interface; and
a secondary mating component configured to be received by a secondary receiving portion of the programming interface,
wherein the one or more conductive pads and the primary mating component are adapted to be deformed by a conductive portion of the primary receiving portion of the programming interface in order to retain the mating connection, and wherein the mating connection provides a communications interface for programming the hearing aid device via the programming interface.

7. The hearing aid device programming connector of claim 6, wherein the mating connection is located on a first end of the hearing aid device programming connector, and an adapter for connecting to a computing device is located on a second end of the hearing aid device programming connector.

8. A hearing aid system comprising:
a hearing aid comprising:
an in-ear component adapted to fit in an ear canal;
a housing comprising:
a microphone configured to capture and convert audio;
memory configured to store one or more programming instructions;
one or more processors configured to modify the audio based on the one or more programming instructions;
a receiver configured to provide the audio to the ear canal;
a battery configured to provide power to the microphone; and
a programming interface comprising:
a primary receiving portion including one or more conductive elements; and
a secondary receiving portion;
a programming connector comprising:
a primary mating component with one or more conductive pads configured to be received by the primary receiving portion; and
a secondary mating component configured to be received by the secondary receiving portion,
wherein the one or more conductive elements place one or more lateral forces on the one or more conductive pads and the primary mating component, deform the one or more conductive pads and the primary mating component,
wherein the primary receiving portion and the secondary receiving portion retain the programming connector within the programming interface, and
wherein the one or more programming instructions are provided via the one or more conductive elements of the primary receiving portion and the one or more conductive pads of the primary mating component.

9. The hearing aid system of claim 8, wherein the programming connector is an electrically-conductive circuit layered upon a substrate.

10. The hearing aid system of claim 9, wherein the substrate is a polyimide substrate.

11. The hearing aid system of claim 8, wherein the one or more conductive pads comprise one or more communications conductors, a ground conductor, and a DC voltage conductor.

12. The hearing aid system of claim 8, wherein the programming connector further comprises a gripping mechanism configured to provide an insertion force towards the primary receiving portion to insert the primary mating component into the primary receiving portion and the secondary mating component into the secondary receiving portion.

13. The hearing aid system of claim 12, wherein the gripping mechanism includes a curvilinear edge.

14. The hearing aid system of claim 13, wherein the curvilinear edge of the primary mating component protrudes approximately 3 mm from the primary mating component.

15. The hearing aid system of claim 8, wherein an edge of the primary mating component which is inserted into the primary receiving portion is approximately 3.6 mm long.

16. The hearing aid system of claim 15, wherein 1 mm of the edge of the primary mating component is inserted into the primary receiving portion.

17. The hearing aid system of claim 8, wherein an edge of the secondary mating component that is received by the secondary receiving portion is 8.4 mm.

18. The hearing aid system of claim 8, wherein the hearing aid is programmed while the in-ear component is located within the ear canal.

19. The hearing aid system of claim 8, wherein the programming interface is a slot interface.

20. The hearing aid system of claim 8, wherein the primary receiving portion is located at an upper portion of the programming interface.
